(19) United States
(12) Patent Application Publication
(10) Pub. No.: US 2006/0045258 A1
(43) Pub. Date: Mar. 2, 2006

(54) Method and apparatus for improved data and video delivery

(76) Inventor: James J. Stiscia, Garner, NC (US)

Correspondence Address: KENNEDY COVINGTON LOBDELL & HICKMAN, LLP, 214 N. TRYON STREET, HEARST TOWER, 47TH FLOOR, CHARLOTTE, NC, 28202, US

(21) Appl. No.: 11/200,314

(22) Filed: Aug. 9, 2005

Related U.S. Application Data
(62) Division of application No. 10/835,982, filed on Apr. 30, 2004.

(51) Int. Cl. H04M 1/76

(52) U.S. Cl. 379/417

(57) ABSTRACT

Systems and methods for improving the quality of service associated with asymmetric digital subscriber line (ADSL) services are disclosed. Such improvements allow for the optimization of service levels and reliability in providing video and data services to subscribers, and in ensuring that such service levels remain acceptable as the number of subscribers on a given loop plant increase.

### CROSS-REFERENCE TO RELATED APPLICATIONS

This application is a Divisional of U.S. application Ser. No. 10/835,982 filed Apr. 30, 2004, the entire content of which is hereby incorporated by reference herein in its entirety.

### FIELD OF THE INVENTION

The present invention relates generally to methods and apparatus utilized for providing communication services over digital subscriber line (DSL) services. More particularly, the present invention discloses novel methods and apparatus for improving the availability, reliability and performance of DSL services when used to provide bandwidth-intensive services such as data and video.

### BACKGROUND OF THE INVENTION

The use of digital subscriber lines (DSL) to provide high speed, wide bandwidth data service over an existing copper cable plant has resulted in rapid growth of such service to homes and businesses. However, as demand has increased, the demands of subscribers for increasing amounts of bandwidth have presented challenges to service providers with regard to their ability to provide a guaranteed quality of service. One variant of DSL, Asymmetric Digital Subscriber Line (ADSL) service, increases the utilization of available bandwidth by restricting upstream bandwidth. By optimizing ADSL performance, service providers can increase the number of eligible subscribers while maintaining the highest possible service quality and reliability, thereby maximizing the revenue potential of their existing copper loop plant. As the types of service provided by ADSL providers has migrated from simple data to complex data streams to video services, quality of service and reliability have become much more important. Current video delivery technologies such as MPEG2 demand high ADSL data rates and error-free performance. Existing ADSL technology is limited in its ability to deliver the bandwidth needed to support multiple set top boxes to a given subscriber. Optimizing ADSL performance requires constant bandwidth and error performance that is consistent over time. Subscriber satisfaction requires such optimized performance since the slightest degradations in video quality are apparent in a way generally unnoticed with data streams. A worse case scenario exists where a subscriber is initially satisfied with the quality of service provided, but is then forced to downgrade to a lower quality of service or lose their service entirely because of performance degradation.

It is recognized in the art that one primary problem with prior art systems is that while a given quality of services can be provided at the time of initialization, such quality of service can be degraded in unanticipated ways. Known solutions to this problem include allocating excess bandwidth to a given copper loop plant, restricting the types of service offerings provided to subscribers, limiting the number of subscribers, or restricting the physical location of subscribers on a given copper loop plant in order to guarantee such quality of service levels. Therefore, a need exists for a system that can provide a desired quality of service without impacting capacity or service offerings.

The present invention discloses apparatus and techniques associated with optimizing ADSL performance without the need to characterize the physical copper loop plant. ADSL service is provided over the existing copper loop plant that provides plain old telephone service (POTS). An ADSL system requires that certain equipment be installed at a telephone central office (CO) to add the ADSL signal to a POTS line, and that additional equipment be installed at a customer's premises (CP) to separate the ADSL signal from the POTS voice signal. The ultimate performance of an ADSL system is determined by the weakest link in such a system, including internally generated noise sources, externally generated stationary noise sources, and externally generated transient noise sources. Internally generated noise sources include thermal noise, quantization noise, power supply noise, and other noise sources that are generated by the ADSL equipment. Externally generated stationary noise sources include noise generated by other equipment in a CO or in a subscriber's CP. Externally generated non-stationary noise sources include POTS signaling noise and other transient noise sources that exist in the CP, a subscriber's CP, and in the loop plant. The performance optimization of an ADSL system is accomplished by controlling each of these noise sources in a systematic fashion. Utilizing the techniques exemplified by the present invention it is possible to significantly improve the performance of ADSL service.

The present invention discloses methods and apparatus which improve the service rates obtainable for providing data and video services over ADSL. Such methods and apparatus are disclosed for Central Office (CO) and Customer Premise (CP) equipment. Implementation of one embodiment of the present invention has been demonstrated to yield improvements of 29.7% in ADSL2+ (ITU G.992.5 standard) access transport networks. The important system level aspects of the invention include increased service rates to video or data subscribers, improved service penetration or reach for ADSL service providers, improved robustness of service for subscribers, and improved operational control as increasing numbers of subscribers operate over a finite cable plant. The implementation of the present invention may lead to improved revenue for service providers by reducing operational costs and increasing the number of subscribers which can be satisfactorily served by a finite cable plant. Subscribers to ADSL service optimized by the present invention will see fewer impairments of video programming as the error rate of the access link is improved.

Further disclosed herein are limitations created by existing ITU-T standards G.992.1, G.992.2, G.992.3, G.992.4, G.992.5 and ANSI T1.413-Issue1/T1.413-Issue 2. Such limitations have to do with a flaw within the existing standards which may cause ADSL service for subscribers on short loops to lose their service as subscribers on long loops are added. A method to overcome this limitation is also disclosed.

Prior art solutions to performance problems with ADSL service have focused on optimizing individual components or over-sizing infrastructure. ADSL service providers typically purchase CO components (such as POTS splitters, cable assembly, interconnection blocks, etc.) from different vendors. Since the service providers and individual component vendors don't typically possess the technical skill required to engineer end-to-end ADSL services, the resulting mix of equipment used does not meet the quality of service requirements disclosed herein. The lack of optimized ADSL service has not yet been identified as a major problem in the industry because the vast majority of existing ADSL subscribers are receiving low bit-rate data services (1.5 Mbps or less), or are receiving higher bit-rate service without a quality of service guarantee from the service provider. As demand for higher bit-rate services increase for such services as multi set-top video service, ADSL service providers will be increasingly pressed in their ability to deliver such services reliably.

### SUMMARY OF THE INVENTION

The present invention recognizes that there exists a need in a variety of contexts for an optimized ADSL system that: (i) provides a means to develop CO equipment which does not limit attainable data rate of the access link due to crosstalk (i.e. inadequate isolation between access links within the same operational environment); (ii) provides a means to overcome limits of the current standards with regards to short loops and long loops for high bit rate delivery systems; (iii) provides a means to decrease operational maintenance costs and improve manageability for ADSL network operators; (iv) provides a means to increase the number of subscribers which can be accommodated for high bit rate ADSL data and video delivery systems to improve obtainable revenue for a given monetary investment in physical plant infrastructure; and (v) provides a means to increase subscriber satisfaction for video delivery systems through the improvement of error rates inherent in prior art ADSL systems.

As described above, prior art systems may have as many as 6 RJ-21 connections in a typical ADSL signal path between a DSLAM and an outdoor cable loop plant. One embodiment of the present invention implements a number of improvements to reduce the power sum NEXT to a level of −66 dB. Firstly, the number of RJ-21 connectors used is minimized, allowing no more than 3 RJ-21 connections in the ADSL signal path. Secondly, the RJ-21 connectors of the present invention are wired in a novel manner that minimizes pair-to-pair crosstalk that minimizes RJ-21 power sum NEXT. Thirdly, all printed circuit board (PCB) layouts and circuit designs are implemented such that the crosstalk levels are all more than 20 dB below any RJ-21 connector contributions. By using a noise design budget, the connectors and interconnection cables become the limiting components in power sum NEXT contribution of the complete ADSL system.

The present invention further recognizes the need for systems and methods that can account for the wide variation in any given outdoor loop plant to optimize the provision of ADSL service irrespective of the characteristics of such loop plant by forcing the transmit levels on adjacent twisted-wire pairs to be the same level. The present invention recognizes that this can be accomplished manually or in an automated manner.

Other advantages of the present invention include: (1) the ability to implement optimal transmit level equalization at the ADSL chip, modem, or system level at the customer premise location; (2) the ability to implement a cost effective central office solution by using common system components; (3) lower cost of operation since limitations of ADSL standards can be overcome in an automated fashion; and (4) increased reliability and quality of service since SNR is limited by the outdoor cable loop plant only rather than by the loop plant and the central office equipment.

### BRIEF DESCRIPTION OF THE DRAWINGS

The invention is better understood by reading the following detailed description of an exemplary embodiment in conjunction with the accompanying drawings, wherein:

FIG. 1 illustrates the typical components of an ADSL system;

FIG. 2 illustrates the frequency spectrum allocated to ADSL service in relation to POTS service;

FIG. 3 illustrates the signal-to-noise ratio (SNR) of an ADSL system as a function of the number of bits used to modulate a signal;

FIG. 4 illustrates the isolation required between an ADSL line and all others if no capacity degradation is to occur;

FIG. 5 illustrates a typical central office (CO) installation of an ADSL;

FIGS. 6A and 6B illustrate pin-out connections used in cabling systems in conjunction with ADSL CO installations;

FIG. 7 illustrates a pin-out connection configuration for use in a connection cable in accordance with the present invention;

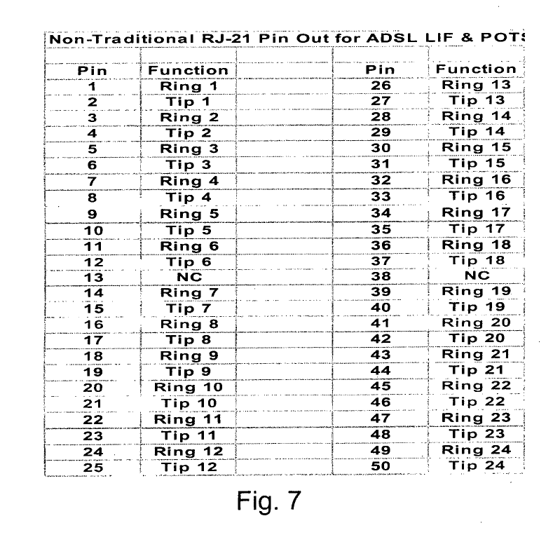

FIG. 8 illustrates a block diagram of the inter-connections through an IDF in accordance with the present invention;

FIG. 9 illustrates a block diagram of a system for providing power cutback;

FIG. 10 illustrates a system for providing power cutback using relays;

FIG. 11 illustrates a method for automatically determining power cutback;

FIG. 12 illustrates a timing diagram of the early phases of an ITU-T G.992.1 initialization procedure;

FIG. 13 illustrates a plot of test results showing attenuation versus frequency for an outdoor cable loop plant using 26 AWG wire;

FIG. 14 illustrates an alternate method for implementing power cutback within an ADSL chip;

FIG. 15 illustrates an alternate method for implementing power cutback using fixed attenuation; and

FIG. 16 illustrates a plot of attenuation versus frequency further illustrating the difference between the optimal characteristic and simulated 26 AWG wire cable.

### DETAILED DESCRIPTION OF THE INVENTION

The following description of the present invention is provided as an enabling teaching of the invention in its best, currently known embodiment. Those skilled in the relevant art will recognize that many changes can be made to the embodiment described, while still obtaining the beneficial results of the present invention. It will also be apparent that some of the desired benefits of the present invention can be obtained by selecting some of the features of the present invention without using other features. Accordingly, those who work in the art will recognize that many modifications and adaptations to the present invention are possible and may even be desirable in certain circumstances, and are a part of the present invention. Thus, the following description is provided as illustrative of the principles of the present invention and not in limitation thereof, since the scope of the present invention is defined by the claims.

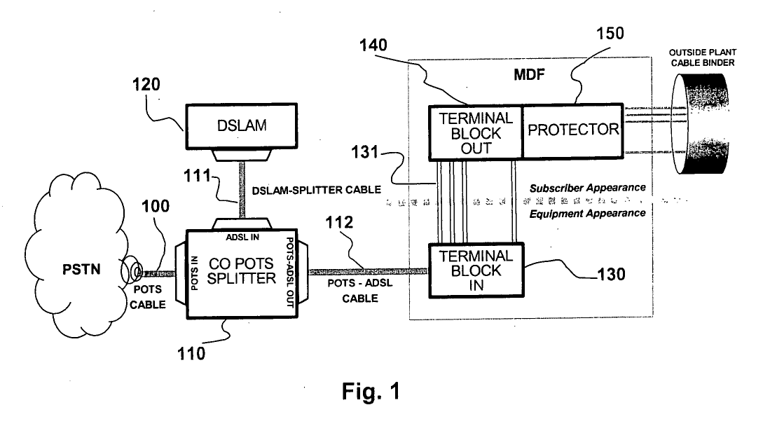

FIG. 1 illustrates the typical components of an ADSL system as installed in a Central Office (CO). A POTS cable 100 carrying multiple twisted pair telephone lines enters a device known as a POTS Splitter 110 and connects the POTS Splitter 110 with the public telephone switched network (PTSN). A device known as a digital subscriber line access multiplexer (DSLAM) 120 is connected to POTS Splitter 110 by a cable 111. The DSLAM is further connected to a non-POTS network, such as an Internet Service Provider (ISP). POTS Splitter 110 multiplexes a data stream from DSLAM 120 with voice signals from the PTSN. A cable 112 connects the POTS Splitter 110 with an Equipment-side Terminal Block 130. Equipment-side Terminal Block 130 is connected to Subscriber-Side Terminal Block 140 by cables 131. Subscriber-Side Terminal Block 140 includes a Protector 150 that protects Subscriber-Side Terminal Block 140 from transient noise from the copper loop plant.

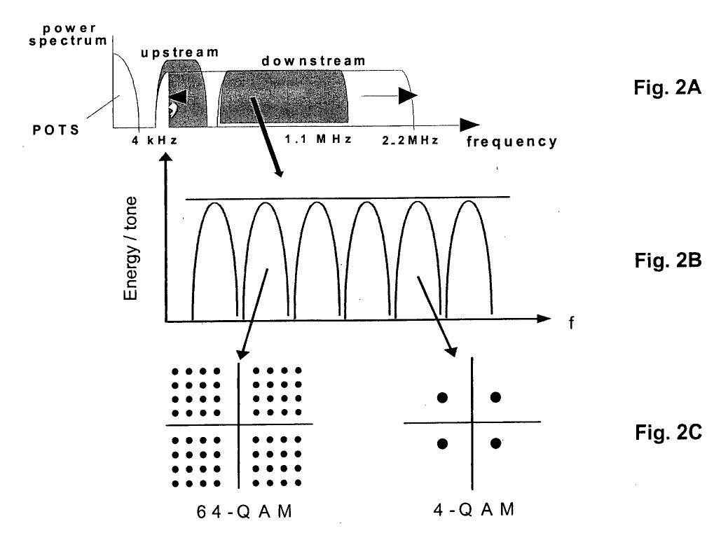

FIG. 2A illustrates the frequency spectrum allocation utilized for ADSL service relative to plain old telephone service (POTS), with a standard POTS voice channels width of 4 KHz. The shaded area shows the 1.1 MHz spectrum width used for frequency division multiplexed (FDM) ADSL service with 1 mega-bit per second (1 Mbps) upstream and 11 Mbps downstream service. The outlined area shows the 2.2 MHz spectrum width used for 24 Mbps ADSL2+ downstream service.

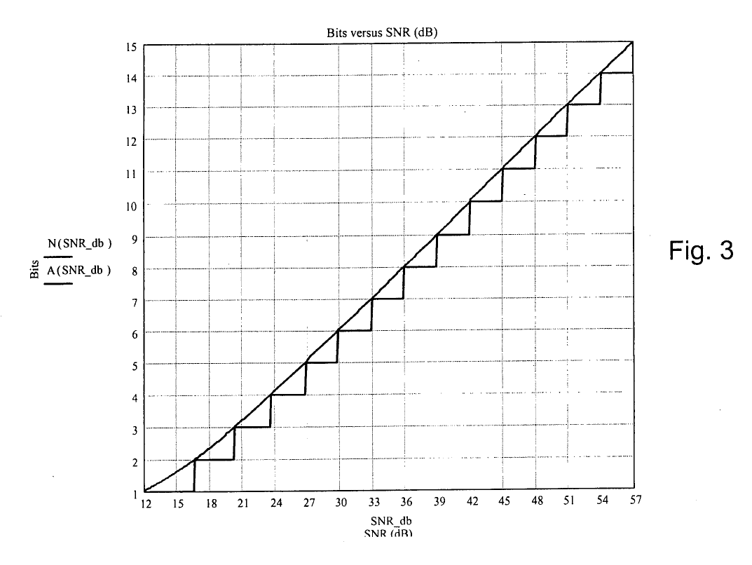

ADSL relies upon discrete multi-tone (DMT) to carry digital data on orthogonal sub-channels spaced at 4.3125 KHz. Each individual tone, as illustrated in FIG. 2B, can be modulated using quadrature amplitude modulation (QAM) with from 1-15 bits. The number of constellation points for each tone is proportional to the number of bits as illustrated in FIG. 2C. For the range of 1-15 bits there are 2-32,768 constellation points. The ability to load each sub-channel depends upon the signal-to-noise ratio (SNR) within that sub-channel. The total capacity of an ADSL link is the sum of the individual sub-channel capacities. FIG. 3 illustrates the difference between being able to load a given number of bits or such number of bits plus one bit as being about 3 dB in SNR.

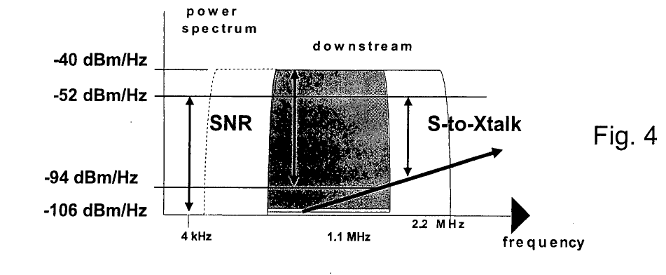

FIG. 4 illustrates the isolation required between an ADSL line and all others if no capacity degradation is to occur. The reference standards (ANSI T1.413 Issue 2, ITU G.992.1, G.992.2, G.992.3, G.992.4, and G.992.5) describe a method which was envisioned to reduce the dynamic range requirements of CP modem receivers. Under the standards, the allocated frequency spectrum is subdivided into 4.3125 KHz frequency sub-channels called bins numbered 1-255 (for standard G.992.1 and G.992.3 ADSL). POTS service is provided on bin 1, and bins 2-5 are reserved as a guard band. ADSL upstream is provided on bins 6-32, and ADSL downstream is provided on bins 33-255. The standard method for determining power cutback requires a CO device to measure the received power on bins 7-18 during link initialization. Based upon the measured received power, the CO transmitter decides whether and how much of a downstream power cutback should be applied. The standards require a power cutback range of 0-12 dB. Since the power cutback amount applied is a function of loop distance, the shortest loops will have the most applied power cutback (−12 dB), and loops beyond approximately 2100 feet (for 26 AWG wire) will have no power cutback applied (0 dB). The number of bits that can be carried in any given bin is limited by the amount of noise present relative to the signal strength of that bin.

Therefore, knowing the basic SNR requirements and the expected signal level differences due to power cutback based on loop characteristics, the isolation requirements can be determined so as to not degrade the data carrying capability of an ADSL system. If the capacity of a frequency bin is to be 14 bits and an additional 6 dB of noise margin to a 10-7 BER is required (as defined by the standards), an SNR of 54.0 dB is required. If a CO transmitter is transmitting at full power the output level based on the standards will be −40 dBm per Hz. As such any crosstalk or noise which is greater than −94 dBm per Hz will degrade the SNR such that less than 14 bits can be loaded on that bin. If a short loop is connected and the CO transmitter is operating at maximum power cutback (−52 dBm per Hz), then the maximum allowable noise level would be −106 dBm per Hz. From these facts the isolation required between an ADSL line and all others is 66 dB if no capacity degradation is to occur.

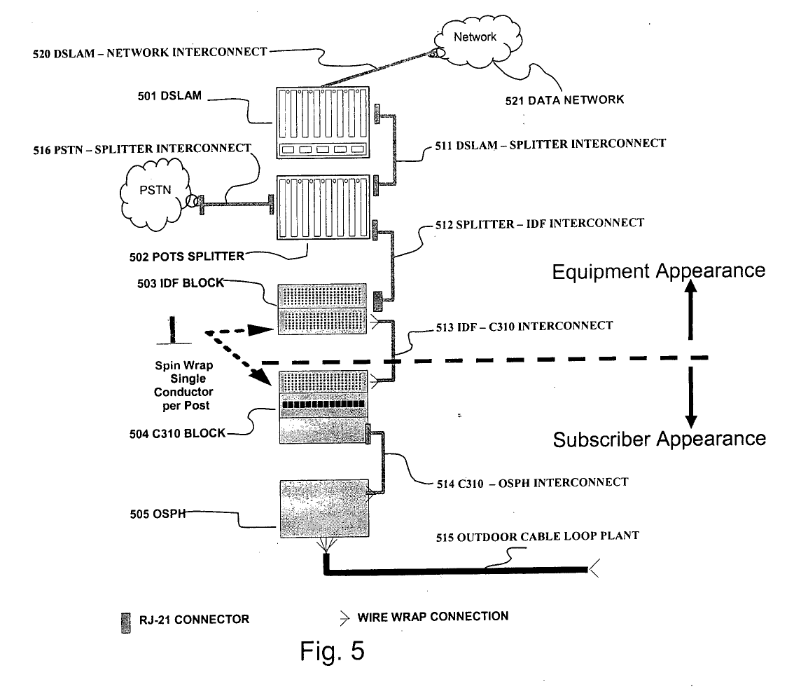

A typical prior art CO contains a number of standard components that are used in the provision and distribution of ADSL service, as illustrated in FIG. 5. A digital subscriber line access multiplexer (DSLAM) 501 contains interfaces to a data network 521 via interface 520 and an output to a POTS splitter 502 via interconnect 511. Interconnect 511 typically consists of one or more 25-twisted-wire-pair cables terminated at each end with RJ-21 connectors wired in a traditional arrangement. The network interface aggregates ADSL service for multiple subscribers back to a data network 521 such as an internet service provider (ISP). The DSLAM 501 comprises an integrated management system that controls the individual interfaces and communicates with external control entities. The network interface 520 connects the DSLAM to the data network at speeds of 100 Mbps or higher. The DSLAM 501 contain line interface cards (LIFs) to translate digital data to the ADSL signal format required for delivery over analog copper twisted pair conductors found in a typical outdoor cable loop plant. POTS splitter 502 combines traditional voice and POTS signaling service with ADSL service in a manner which prevents POTS service from degrading ADSL service quality. POTS splitter 502 is connected to intermediate distribution frame (IDF) 503 via interconnect 512. Interconnect 512 typically consists of one or more 25-twisted-wire-pair cables terminated at each end with RJ-21 connectors wired in a traditional arrangement. POTS splitter 502 is further connected to a public switched telephone network (PSTN) via interconnect 516. IDF 503 defines an interface point between the outdoor loop plant and the interior environment of the CO. The inputs of the IDF 503 are typically protected by protection circuits located in a device known as a C310 block, such as input block 504. IDF 503 and input block 504 are connected by individual twisted pair conductors, each of which is terminated by spin-wrap connections (single conductor per post). Input block 504 is connected to outdoor subscriber plant handling (OSPH) 505 by interconnect 514, which typically consists of 25 or more pairs of CAT3 cable. OSPH 505 is the final interface to outdoor cable loop plant 515.

DSLAM 501 aggregates subscriber bandwidth from ADSL LIF modules and forwards the composite traffic to a data network such as an internet protocol metropolitan area network (IP-MAN) via a wide area network (WAN) interface. From the IP-MAN, via the DSLAM WAN interface, data traffic is routed to an ADSL LIF connected to a given subscriber via twisted pair cable loop plant. This DSLAM wide area interface (WIF) follows applicable standards for Ethernet developed in the 802.3 IEEE working group and may operate at speeds from 100 Mbps through 10 giga-bit per second (Gbps). Each ADSL line interface contains CO modems following the applicable ANSI or ITU-T access equipment standards. These standards define the signaling protocol for the physical layer link between the CO and the CP equipment (CPE). The ADSL LIF converts the IP data into the ADSL asynchronous transfer mode (ATM) protocol that is used in accordance with the ANSI and ITU ADSL standards. Data flows into/out of the LIF from the back of the card (via the backplane) and out/in to the front of the LIF so as to avoid the inherent crosstalk brought on by “rear access” DSLAM construction. In one embodiment of the present invention, the DSLAM is designed such that the digital signals originate and terminate from the backplane of the DSLAM, and the analog signals originate and terminate from the line interfaces on the front panel of such a DSLAM. By physically isolating the digital signals and the high frequency harmonic content associated therewith from the analog signals, crosstalk is minimized. Data is modulated onto individual tones called bins, with framing overhead, operations channel overhead, and error correction overhead added and combined into discrete multi-tone (DMT) symbols. These DMT symbols are then converted into analog signals and coupled onto the twisted pair cable. Each ADSL LIF serves multiple subscribers and hence connects to multiple twisted-wire pairs. Connections to the twisted pairs are typically made via cables terminated with RJ-21 connectors. Typical LIFs serve 8, 16, or 24 subscribers via 50 pin RJ-2 1 connectors.

POTS splitter 502 as illustrated in FIG. 5 combines the analog telephony signal normally associated with the 0-4 KHz frequency band of POTS and the ADSL signals in a manner so that the two services do not negatively interact. Since POTS signaling can contain very high levels of out of band energy (i.e. frequency content in the ADSL band of 25-2208 KHz) during ordinary signaling events such as ringing a telephone, opening and closing a dialer contactor, or a user picking up a ringing telephone when the ring voltage is active, a filter function must be included to prevent POTS signals from degrading ADSL service quality. Similarly the ADSL band energy can cause frequency components or “noise” in the POTS band through non-linearities in semiconductor devices typically used in POTS electronic circuitry. Therefore, the POTS circuitry must be isolated from the ADSL signals to prevent these non-linear effects from degrading POTS service quality. A typical POTS splitter uses three RJ-21 connectors to connect to the PSTN, the ADSL LIF, and the intermediate distribution frame (IDF). These connectors typically utilize 25 pair CAT3 cabling for the connections to the ADSL LIF and IDF (combined ADSL and POTS signals). A typical POTS splitter utilizes multiple splitter cards, with each card typically providing 24 lines of service. Accordingly, only 24 twisted pairs of each 25 pair cable are used.

A distribution frame, such as a main distribution frame (MDF) or an intermediate distribution frame (IDF), receives combined ADSL/POTS signals (i.e. downstream signals) from the POTS splitter, as well as ADSL/POTS signals from the outdoor cable loop plant (i.e. upstream signals). The primary function provided by an MDF or IDF is to provide an access point where combined POTS/ADSL service ports can be easily connected to a particular subscriber. Since each subscriber is connected to a dedicated twisted pair cable through an outside cable loop plant, a CAT3 jumper wire is typically connected from the MDF or IDF frame to the access point for that subscriber. Traditional CO components typically use RJ-21 connectors to allow cabling between the IDF and POTS/ADSL port of a POTS splitter. The mating female end of a typical RJ-21 connector mounted on the IDF is connected to wire wrap pins on the back side of the IDF with untwisted wire.

A protection device commonly known as a C310 block contains primary protection to prevent any harmful electrical transient signals from entering the CO due to lightning or other environmental effects which occur outside the CO. The outdoor loop plant cable pairs enter the CO in individual cables and are grouped into binder groups and binder layers. These individual cables may contain as few as 25 twisted-wire pairs or as many as thousands of twisted-wire pairs within a single cable. These cables are typically CAT3 or lower rated. The C310 block contains pins to which the outdoor loop plant cable twisted-wire pairs typically are wire wrapped to the back side if the block. The pins extend through the block so that the CAT5 jumper wire from the IDF may be wire wrapped in order to connect a particular combined POTS/ADSL port to a particular twisted pair (subscriber).

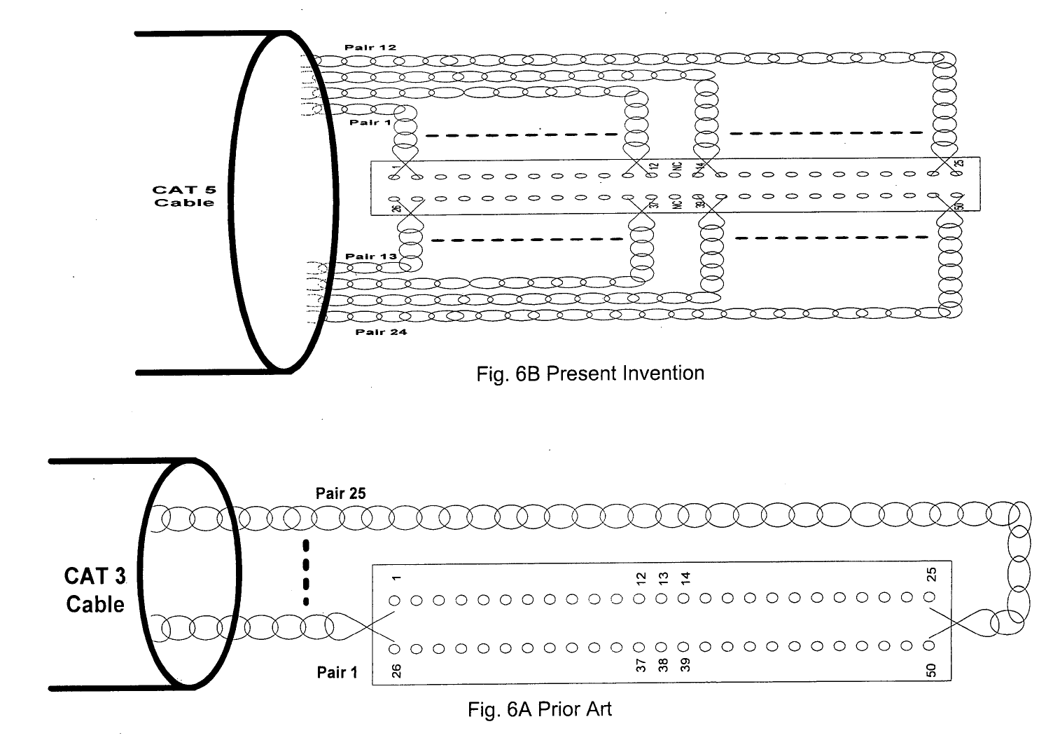

CO equipment commonly uses 25 twisted-wire pair cabling that is terminated in 50-pin amphenol-type RJ-21 connectors. The standard RJ-21 connector is traditionally wired such that twisted-wire pair 1 uses pin 1 for the ring signal and pin 26 for the tip signal of the RJ-21 connector. Each successive twisted-wire pair then uses each successive pin pair such that pair 2 uses pins 2 and 27; pair 3 uses pins 3 and 28, and so on, as illustrated in FIG. 6A. Wiring the tip and ring pairs in this conventional manner leads to a crosstalk level of between −61 to −64 dB for adjacent pairs. The crosstalk level decreases by about 6-8 dB per each additional position from the adjacent pair. Since multiple pieces of CO equipment contain RJ-21 connectors wired in this manner exist within a typical CO, the net degradation which occurs due to the power sum NEXT of all connectors and all equipment can be much greater than for an individual connector alone. Test results have yielded power sum NEXT degradations of as high as −43.5 dB in commercially available and deployed products of the prior art. This net signal degradation is 22.5 dB greater than the previously noted −66 dB requirement.

FIG. 6A illustrates the pin-out connection used in prior art RJ-21 connectors. The prior art system uses cables consisting of 25 unshielded twisted-wire pairs (typically ANSI CAT-3 quality) terminated in 50-pin amphenol-type RJ-21 connectors. The prior art pin-out arrangement is such that twisted-wire pair 1 uses pin 1 for the ring signal and pin 26 for the tip signal of the RJ-21 connector. Each successive twisted-wire pair then uses each successive pin pair such that pair 2 uses pins 2 and 27; pair 3 uses pins 3 and 28, and so on. Even though most CO equipment is designed to scale in increments of 24 lines, most cables wire all 25 twisted-wire pairs. Wiring the tip and ring pairs in this conventional manner leads to a crosstalk level of between −61 to −64 dB for adjacent pairs. The crosstalk level decreases by about 6-8 dB per each additional position from the adjacent pair.

FIG. 6B illustrates the pin-out connection for the RJ-21 connector and cable of the present invention. Twisted-wire pair 1 uses pin 1 for the ring signal and pin 2 for the tip signal of the RJ-21 connector. Twisted-wire pairs 2, 3, 4, 5, and 6 use pins 3, 5, 7, 9, and 11 for the ring signals and pins 4, 6, 8, 10, and 12 for the tip signals of the RJ-21 connector. Twisted-wire pairs 7, 8, 9, 10, 11, and 12 use pins 14, 16, 18, 20, 22, and 24 for the ring signals and pins 15, 17, 19, 21, 23, and 25 for the tip signals of the RJ-21 connector. Twisted-wire pairs 13-24 are arranged similarly using pins 26-50. Pins 13 and 38 are left unconnected. Wiring the tip and ring pairs in this manner leads to a crosstalk level of between −76 to −78 dB for adjacent pairs with a crosstalk level that decreases by about 8-10 dB per each additional position from the adjacent pair. This yields an improvement of 14 dB or more over the RJ-21 wiring pin-out arrangement of the prior art. Since ADSL LIFs provide port numbers which are multiples of 8, and the maximum number of ports used in a typical 25 pair connector is 24 ports, pins 13 and 38 are left unconnected to further minimize connector crosstalk. In an alternate embodiment of the present invention, pins 13 and 38 are connected to a low impedance ground return source on the CO equipment side. In another alternate embodiment of the present invention, ANSI CAT-5 quality cable consisting of 25 unshielded twisted-wire pairs is used. It is also possible to use 25 twisted-wire pair cable that is wrapped in a conductive sheath, and such sheath may be electrically terminated to a conductive shell 50-pin amphenol-type RJ-21 connector, and/or further connected to pins 13 and 38.

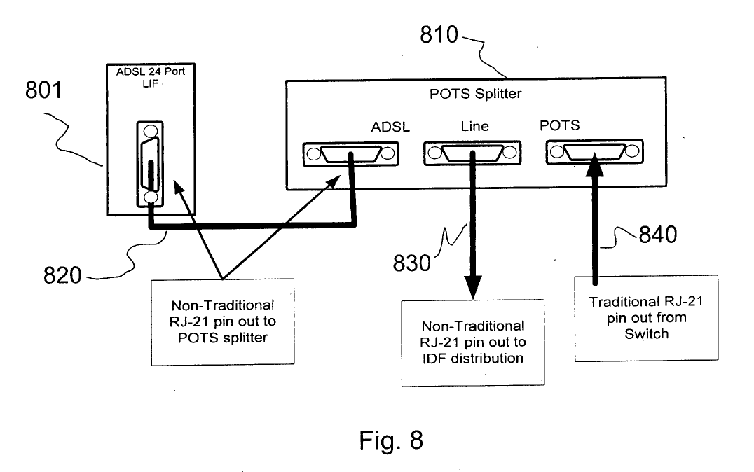

As illustrated in FIG. 8, the wiring pin-out of the present invention is used for LIF and POTS splitter connectors which carry ADSL or combined ADSL/POTS signals in the system of the present invention. CAT5 grade cabling is used for all ADSL LIF and POTS splitter cables. In order to be compatible with POTS service provided by the PTSN, the connector from the POTS splitter POTS filter to the PSTN uses a conventionally wired RJ-21 cable. Since the internal POTS filter of the POTS splitter isolates this connector from the ADSL signal, no degradation is observed from using this conventionally wired cable.

Further improvement is observed by implementing the IDF block such that the CAT5 cable connecting it to the POTS splitter is connected at the IDF block by wiring directly to the pins using wire wrap technology implemented with controlled twist to within one-quarter inch of the pins. The system of the present invention yields a solution which provides −66 dB of isolation through the ADSL2+ operational frequency range. Accordingly, there is no impact of the CO equipment upon the attainable data rate for such service.

Improvements in CO equipment are generally predictable and measurable since such equipment is typically operated in a known, controlled physical environment. However, the typical outdoor cable plant that connects the CO equipment to CP equipment has a significant impact upon the total port-to-port isolation of the system as a whole. CO equipment can provide adequate port-to-port isolation using the techniques disclosed herein, in which case the pair-to-pair crosstalk of the outdoor cable plant will then dominate the port-to-port isolation of an ADSL system. The referenced standards all define service rates based upon a concept of a 99% worst case coupling factor for crosstalk. This factor means that only 1% of the loop plant will have a crosstalk coupling which is worse than this value. Since crosstalk is characterized by a Gaussian probability distribution function, other crosstalk levels are easily calculated. However the actual crosstalk varies widely from pair-to-pair. The wide variation in possible NEXT values in the outdoor cable plant leads to the situation where loops transmitting at maximum power can degrade service rates for loops transmitting at less than maximum power. For the condition where two loops are operating at the 90% NEXT level, the coupling from one loop into the other will be at a level of −58 dB@ 1104 KHz. If a long loop is transmitting at full power (−40 dBm per Hz), this leads to an interference level of −98 dBm per Hz into the other loop. If the other loop happens to be a short loop operating with maximum power cutback (−52 dBm per Hz), the SNR available is 46 dB. It is established that the SNR required is 54 dB for 14 bit bin loading. Therefore, if a short loop is brought into service first, and then a long loop is later brought into service, the short loop will experience severe data capacity degradation. For the case where a short loop is capable of operating at 10 Mbps (in G.992.1 mode for example), the amount of degradation can render that short loop incapable of operating above 7 Mbps. Since a minimum of 8 Mbps is required to support a subscriber that desires high quality video service (assuming 2 video set-top box service) using MPEG2 encoding, it is possible for such a subscriber to obtain service only to lose the necessary quality of service when the long loop is brought into service. This is clearly an unacceptable situation that was not anticipated at the time ADSL service was first deployed since multiple set top box video service did not exist. The above power cutback mechanism is required by the standards and is incorporated into ADSL modems which comply with such standards. Since outdoor loop plant NEXT levels vary widely in the field, the impact of the above scenario is not always readily obvious to ADSL system providers. One solution to this problem is to force the transmit levels of adjacent pairs to be the same level. The present invention recognizes that this can be accomplished manually or in an automated manner.

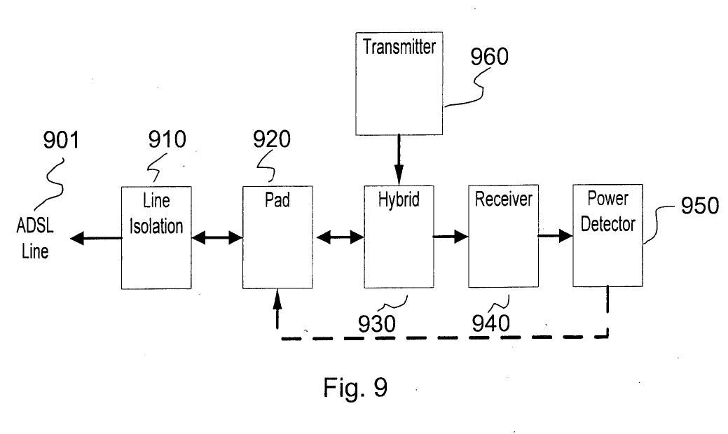

FIG. 9 illustrates an ADSL modem that varies the power output level such that the addition of a new loop will not degrade the performance of ADSL service that is provided on an existing loop. The ADSL modem of FIG. 9 contains a number of common functional blocks. Line isolation block 910 decouples the modem circuitry from the twisted pair cable of the loop plant and typically provides impedance matching. A hybrid circuit 930 converts the two-wire signal of the differential pair to a four-wire signal for the transmitter circuitry 960 and the receiver circuitry 940. In one embodiment of the present invention, a pad element 920 can be added to reduce both the local transmit and receive levels within the modem. If the transmit power of transmitter 960 is reduced when the modem is connected to a short loop operating in power cutback mode, then the far-end modem in the associated CO will assume that the cable is longer and not apply any downstream power cutback. If no downstream power cutback is applied, then the SNR is increased within the outdoor cable plant since all transmitters are operating at the same power level. This additional loss must be removed when the loop is relatively long (more than about 2100 feet of 26 AWG by way of example) or data capacity will be lost. Pad 920 would provide a loss equal to the amount of the expected downstream power cutback. In its simplest implementation, pad 920 would be fixed at the maximum expected power cutback difference of 12 dB, and would be impedance matched so as to present the correct characteristic impedance to the connected twisted pair 901, line isolation 910, and hybrid circuit 930.

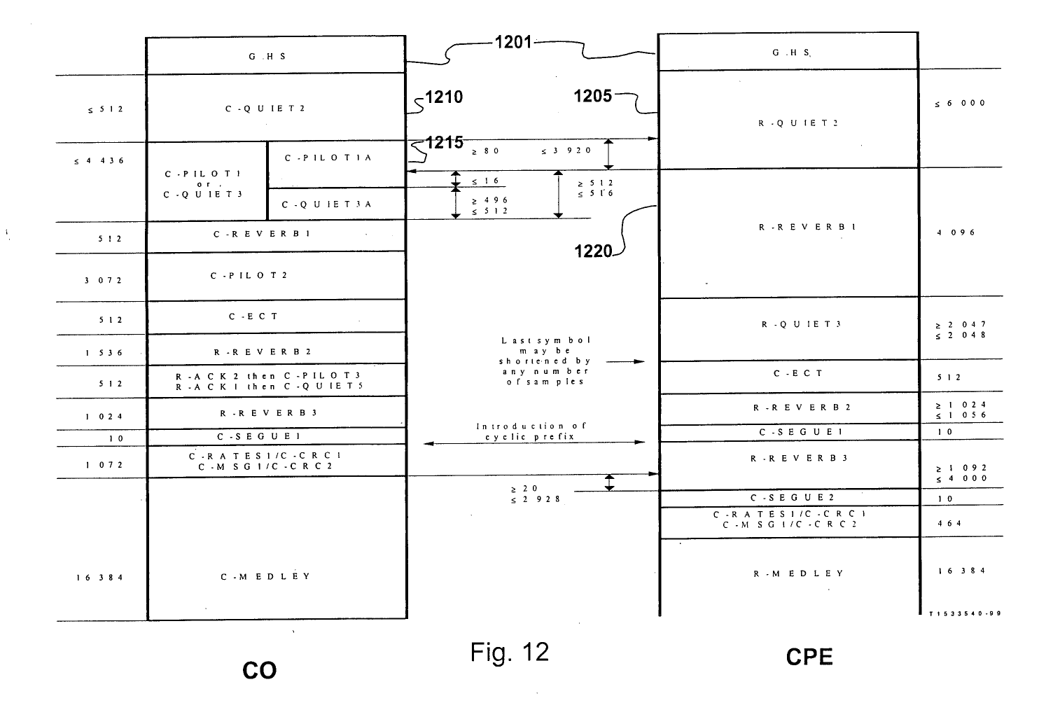

Placing pad 920 in the signal path requires that the modem of FIG. 9 dynamically detect the need for power cutback in order to insert pad 920 at the appropriate time in the training operation (as described in detail below at FIG. 12). The modem must identify the tone sets being transmitted from the far end modem in the CO using power detector 950, calculate the transmit power for the tone sets used (tone sets and transmit levels are specified in the ANSI and ITU standards), calculate the loss between the CO and CP, determine if the loss will result in downstream power cutback application, monitor progress of the G.HS handshake parameter negotiation phase, and insert the attenuation at the proper time (i.e. before translation to ADSL training but after completion of G.HS). In one embodiment of the present invention, pad 920 could be switched in or bypassed via use of relays and a suitable control signal.

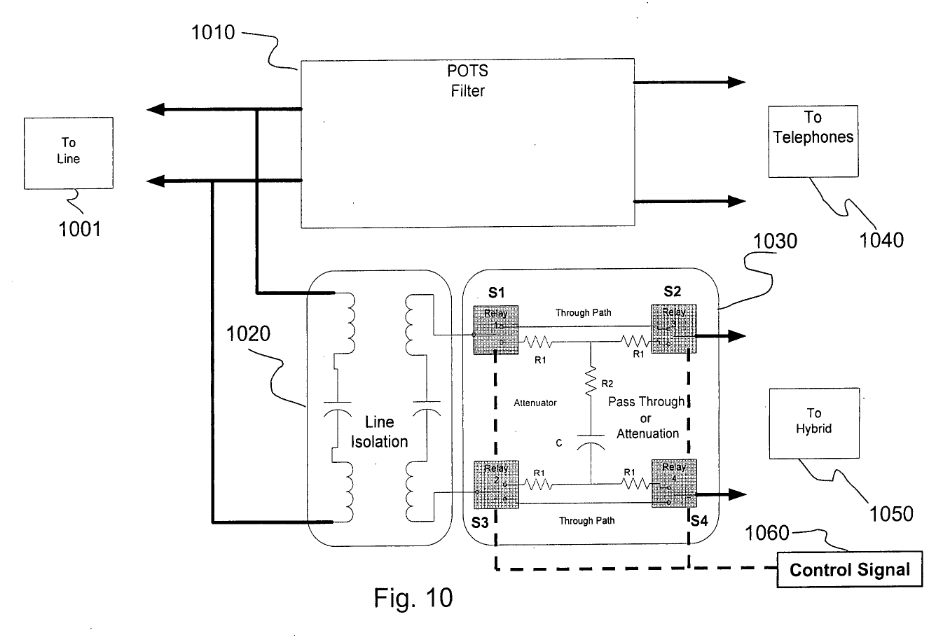

FIG. 10 illustrates an apparatus used to switch in or bypass a pad, such as pad 920 illustrated in FIG. 9, via the use of relays and a suitable control signal. Line 1001 of an outdoor cable loop plant enters POTS filter 1010, which is designed to allow POTS to pass through to standard CP telephone handsets such as handset 1040. POTS filter 1010 is also suitably enabled to block transient signals associated with signaling noise generated by handset 1040 from entering hybrid block 1050. Line 1001 is also connected to line isolation module 1020 which blocks noise transients and quiescent dc currents from passing through to hybrid block 1050. Line isolation module 1020 comprises a line isolation transformer and center tap coupling capacitors, thereby presenting a suitably high impedance to POTS signals to block all such frequencies from attenuation pad 1030. Attenuation pad 1030 comprises relays S1, S2, S3, S4, resistors R1 and R2, and capacitor C. Relays S1, S2, S3, and S4 are simultaneously switched by an activation signal 1060 generated by a power detector such as power detector 950 of FIG. 9. When relays S1, S2, S3, and S4 are switched off, the attenuation path is bypassed and the full signal is allowed to pass through to hybrid block 1050. When relays S1, S2, S3, and S4 are switched on, the attenuation path is switched in and attenuation is provided for power cutback by R1, R2 and C. By adjusting the values of R1 and R2, the attenuation level is controlled. By adjusting the value of C, the frequency at which attenuation reaches the desired level is controlled.

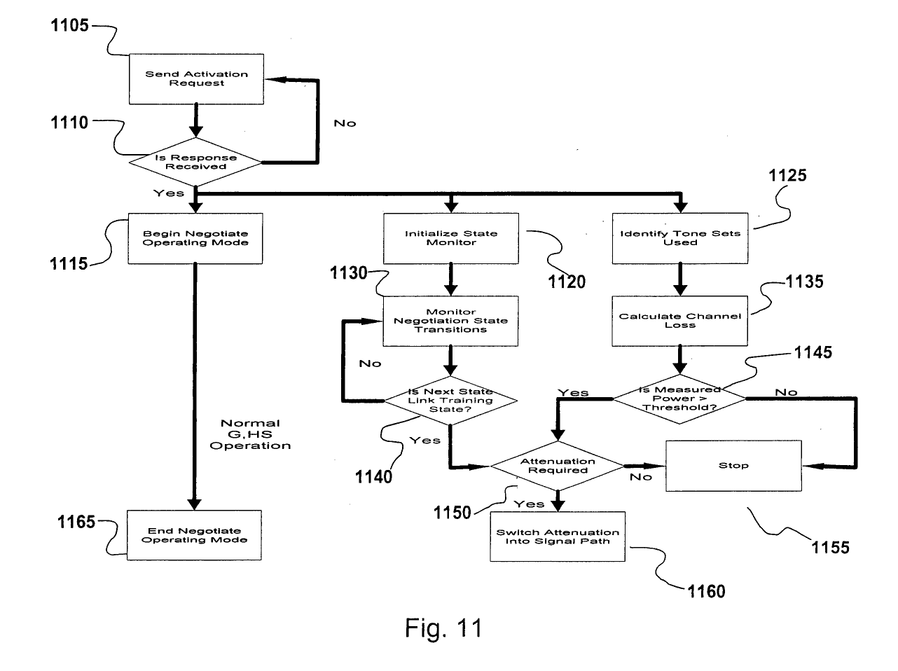

FIG. 11 illustrates a process whereby a modem of the present invention determines whether to switch in or bypass a pad, such as pad 920 illustrated in FIG. 9, via the use a control signal. The process begins at step 1105 when an activation request is sent to the modem. At step 1110, the process determines whether a response to the activation request of step 1105 has been received. If not, the process loops back to step 1105. If a response to the activation request has been received, the process proceeds simultaneously to steps 1115, 1120, and 1125. At step 1115 a process is started to negotiate the operating mode of the modem. At step 1120 a process is started where the state monitor is initialized. At step 1125 a process is started to identify the tone sets to be used are identified.

The normal G.HS (ITU G.994.1) handshake negotiation process of step 1115 allows the CO and CPE to exchange capabilities and select the operating modes to be used by the ADSL link through a message exchange process. During the process illustrated in FIG. 11 the CPE modem performs the parallel tasks following the branch of step 1125. Also in parallel with the G.HS process, the CPE modem monitors the G.HS state changes, as shown in the branch of step 1120, in order to be able to determine when the G.HS process will be completed. The correct time to switch in the attenuation at step 1160 is during the transition from the G.HS phase to the training phase (as illustrated by R-Quiet2 in FIG. 12). The attenuation can't be switched in during the G.HS process because doing so would cause an abrupt change in signal level at the CO receiver. This could lead to incorrect decoding of G.HS messages since the receiver automatic gain control might not be able to track the change correctly. Accordingly, the process illustrated in FIG. 11 comprises the normal G.HS operation used in modems today (as shown in the branch of step 1115) as well as the additional parallel processes of the present invention (as shown in the branches of steps 1120 and 1125) to determine if attenuation is required and determine when such attenuation should be switched in. If the measured power threshold does not determine that attenuation is required, the parallel processing can cease at step 1155.

The process branch of step 1125 continues at step 1135 where the process calculates the signal loss for the channel, and the process proceeds to step 1145. At step 1145, the process determines whether the measured power of the signal exceeds a certain threshold. If not, power cutback is not required. Therefore, the pad activation signal is not generated, the pad is not enabled, and this branch of the process ends at step 1155. If it is determined at step 1145 that the measured power of the signal exceeds a certain threshold, the process proceeds to step 1150. At step 1150, the process determines whether power cutback is required. If so, this branch of the process proceeds to step 1160, the pad activation signal is generated and the pad will be enabled upon the completion of the G.HS handshake process at step 1165. The attenuation cannot be switched in until after the G.HS process is completed because the messages exchanged could be corrupted by the instantaneous signal level change. Thus the point where G.HS will finish and the link will transition to the next training state (R-Quiet2 as illustrated in FIG. 12) must be determined. Since R-Quiet2 is a period where the CPE transmits no signals (is “Quiet”), and determines the boundary between the G.HS and DMT training, the attenuation can then be switched in. Thus the next signal transmitted by the CPE (R-REVERB1 as illustrated in FIG. 12) will be reduced by attenuator 1030 of FIG. 10 and the CO modem will be expecting to adjust its own receiver automatic gain control

The process branch of step 1120 continues at step 1130 where a state monitor detects state transitions and monitors for the completion of the G.HS phase. Proceeding to step 1140, the process determines whether the next state is a link training state. If not, the process branch loops back to step 1130, and if so, the process proceeds to step 1150. At step 1150, the process determines whether power cutback is required. If so, the process proceeds to step 1160, the pad activation signal is generated and the pad is enabled, and the process ends. In summary, when the process determines that attenuation is required at step 1150, and the process further determines at step 1140 that the next state will be the link training state, then the process proceeds to step 1160 where a control signal, such as control signal 1060 as illustrated in FIG. 10, is generated indicating that attenuation should be switched into the ADSL signal path.

FIG. 12 illustrates a training process whereby the G.HS handshake process is used by a CO modem and a CPE modem to exchange information related to each modems capabilities, and to set appropriate operating parameters of each device. Upon completion of G.HS at step 1201, each modem signals the other modem that G.HS is complete, and the modems transition to their respective x-QUIET2 state. The CO modem then initiates a transition to a transceiver training state by sending either a C-PILOT1 or a C-QUIET3 message at step 1215 (as negotiated during G.HS process). The CPE modem then transmits a R-REVERB1 message at step 1220, which is them received by the CO modem at step 1215 and used to determine if the CO modem should transmit its downstream signal at full power or some lower power cutback level. The remainder of the training process is used to determine relevant attributes of the connecting channel and establish transmission/processing attributes suitable to carrying data within the channel. The process illustrated in FIG. 12 is a basic start up process under the G.992.1 and G.992.2 standards. Additional process steps are involved under the G.992.3 and G.992.5 standards, but don't fundamentally change the concept as illustrated. The link transition point in the decision process for the CP modem would occur during the detection of C-QUIET2 in the ITU training process.

The steps involved in the optimal implementation of power cutback compensation are best illustrated by a working example. Assume that an ADSL provider wishes to initialize high rate video service for a subscriber based upon the G.992.5 ITU-T standard. The service must deliver a guaranteed user data rate of 22 Mbps or it will fail. The ADSL provider has limited loop plant records, but such records are ambiguous and the twisted pair distance to the subscriber in question is only known to be somewhere in the range of 1000 to 2000 feet. Also, the actual installed wire gauge is unknown. The subscriber will be serviced from outdoor cable plant where the number of other subscribers receiving service from within the same cable pair binder group is high. The ADSL provider mails the CPE, an ADSL modem, to the subscriber and the subscriber installs the CPE. In this example, an automated power cutback solution is required because: (a) when the wire gauge is unknown, the power cutback level could be in the 2-12 dB range; (b) the new service will be installed in a high service penetration area so the chances that the crosstalk contribution from the outdoor cable plant into the twisted pair for the new subscriber will be significant; (c) the loss in user capacity if short loop compensation is not applied has the potential to be over 6 Mbps which would drive the attainable user rate from 26 Mbps capacity (of the G.992.5 standard) to less than 20 Mbps; and (d) there will be no technician present at the subscriber's premise to perform the service initialization. Therefore, the ADSL service provider will pre-provision the service and start up will occur automatically when the subscriber connects the modem to the loop plant. When the subscriber connects the CPE modem to the loop plant and powers up the ADSL modem, the link will first enter the handshaking state G.HS described by the ITU-T G.994.1 standard. The CO modem has the option to send the signal sets and levels shown in the following table:

| | | | | | Peak |
|---|---|---|---|---|---|
| | | | Power | Total | to Peak |
| Tone | | | per Tone | Power | Voltage |
| Set | Direction | Indices | Tone [dBm] | [dBm] | [Vpp] |
| A43 | Downstream | 40, 56, 64 | −3.65 | +1.12 | 1.02 |
| B43 | Downstream | 72, 88, 96 | −3.65 | +1.12 | 1.02 |
| A43 & | Downstream | 40, 56, 64, 72, | −3.65 | +4.13 | 1.44 |
| B43 | | 88, 96 | | | |

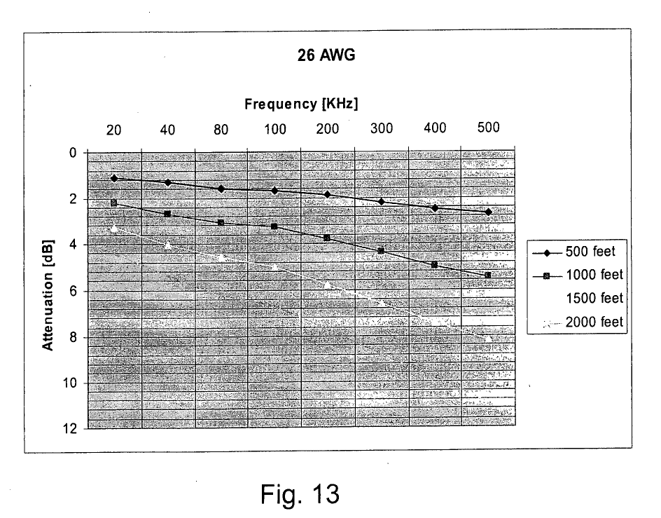

The CPE modem does not know in advance whether the A43, B43, or combined A43 & B43 tone sets will be transmitted. As such the CPE modem must be able to identify which of these tone sets is being sent. This would be determined by checking the frequency bands occupied by the tone indices groupings (for example 172.5, 241.5, and 276.0 KHz regions for tone set A) through the application of a fast Fourier transformation (FFT) to the signal, or other similar measurement mechanism. Once the tone set or sets used are identified, the power received for each tone would be measured using a suitable algorithm. Since the power transmitted per tone is known as well as the frequency locations of the tones, an estimate of what the twisted pair channel loss for bins 7-18 can be made. The attenuation versus frequency for 26 AWG wire for lengths of 500 to 2000 feet in increments is shown in FIG. 13.

By means of a suitable algorithm, the CPE modem can calculate the absolute attenuation each received G.HS tone experiences as well as the relative difference between tones. In this manner the absolute attenuation and slope of the attenuation curve can be used to determine the estimated attenuation in the bin 7-18 frequency range which will be experienced in later training phases (i.e. specifically R-REVERB1). For this example, assume the algorithm calculates the power that would be received by the CO in bins 7-18 (if they were being transmitted by the CPE at −38 dBm per Hz) is +8.5 dBm. From the table below it is apparent that the CO modem in that condition would apply a downstream power cutback of 10 dB.

Parameter

| | | | | | | | |
|---|---|---|---|---|---|---|---|
| Upstream received | 3 | 4 | 5 | 6 | 7 | 8 | 9 |
| power for bins 7-18 | | | | | | | |
| [dBm]< | | | | | | | |
| Transmit loss for bins | 6 | 5 | 4 | 3 | 2 | 1 | 0 |
| 7-18 [dB] | | | | | | | |
| Maximum downstream | −40 | −42 | −44 | −46 | −48 | −50 | −52 |
| PSD to be transmitted | | | | | | | |
| based upon above bin | | | | | | | |
| 7-18 condition | | | | | | | |
| [dBm/Hz] | | | | | | | |
| Applied downstream | 0 | 2 | 4 | 6 | 8 | 10 | 12 |
| power cutback at this | | | | | | | |
| PSD[dB] | | | | | | | |

From the flow chart of the method illustrated in FIG. 11, the CPE modem has so far successfully completed the activation phase, entered the G.HS operation phase, identified the tone sets used, calculated the channel loss, determined an estimate which predicts the CO modem will apply a 10 dB downstream power cutback during the later training phase R-REVERB 1, and monitored the state of the existing G.HS session. Since the power threshold has been determined, a power cutback of 10 dB will be applied if no later action is taken to influence the CO modem, and the CPE modem determines that attenuation is required to the upstream transmit signals after the G.HS phase. Based on this estimated 10 dB of power cutback, the upstream transmit level to cause the CO modem to receive a total of +3 dBm or less can be calculated based upon the earlier estimated attenuation of the bin 7-18 frequency range. Since the estimated power the CO would receive is +8.5 dBm for bins 7-18, enough attenuation to reduce this to +3 dBm or 5.5 dB attenuation must be applied to the upstream transmitter beginning with the R-REVERB1 phase and for the duration of the training/operational state process. Since the downstream signal received by the CPE without influencing the CO would be 10 dB lower, the same 10 dB of attenuation must be switched into the receive signal path to prevent overload. This would be switched in at R-REVERB1 when the upstream 5.5 dB digital attenuation is applied, or earlier during the R-QUIET2 training phase. Either time point is acceptable. The digital attenuation of the upstream transmit signal from the CPE modem would be applied by simply reducing the transmit DAC input level by 5.5 dB. The receive attenuation of 10 dB would be switched in by reducing amplifier input gain by 10 dB if the amplifier had sufficient dynamic range or through means of an attenuation network if not.

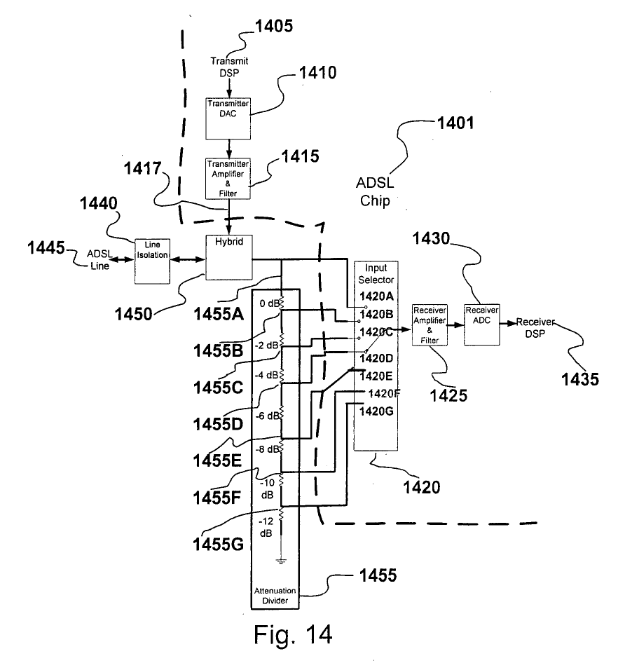

In an alternate embodiment of the present invention, the power cutback process is implemented using an integrated circuit chip with an external attenuation element as illustrated in FIG. 14. ADSL chip 1401 comprises an input 1405 from a transmit digital signal processor (DSP), a transmitter digital-to-analog (DAC) converter 1410, a transmitter amplifier and filter 1415, an attenuation selector 1420, a receiver amplifier and filter 1425, a receiver analog-to-digital (ADC) converter 1430, and an output 1435 to a receiver DSP. ADSL chip 1401 further comprises an output 1417 that connects to an external hybrid block 1450. Hybrid block 1450 is further connected to attenuation divider 1455 and input selector 1420 via input 1420A. Hybrid block 1450 is further connected to line isolation block 1440, which in turn is connected to ADSL line 1445. Attenuation divider 1455 comprises attenuation elements 1455A-G, which is connected to input selector 1420 via inputs 1420A-G.

Following the structure of the process described in FIG. 12, assume that the CPE modem has completed the activation phase, entered the G.HS phase, identified the tone sets used, calculated the channel loss, computed an estimate which predicts that the CO modem will apply a 10 dB downstream power cutback during the later training phase R-REVERB1 (further assuming that the attenuation was not switched in), and monitored the state of the existing G.HS session. Since the power threshold has determined that a power cutback of 10 dB will be applied by the CO if no action is taken to influence the CO modem, the CPE modem determines that attenuation is required to the upstream transmit signals after the G.HS phase is completed. Based on this estimate of 10 dB of power cutback, the upstream transmit level that will result in the CO modem receiving a total signal strength of +3 dBm or less can be calculated based upon the earlier estimated attenuation of the bin 7-18 frequency range. Since the estimated power the CO modem would receive is +8.5 dBm for bins 7-18, sufficient attenuation must be switched in to reduce this to +3 dBm. That is, 5.5 dB of attenuation must be switched in before the CPE modem begins transmitting R-REVERB1 and for the remainder of the operating states. Since the CO modem will then transmit a full power signal, the downstream signal received by the CPE modem will be 10 dB higher than if the upstream signal level had not been reduced by 5.5 dB. Thus the CPE modem must switch in the transmit attenuation by applying a −5.5 dB scaling factor to signals exiting the transmitter DAC 1410 of FIG. 14. Simultaneously, the CPE modem must control the input selector within ADSL chip 1401 so as to select the attenuated signal input corresponding to a −10 dB input level (input 1420F). The timing of these selections can be such that they are automatically applied at either the beginning of R-QUIET2 or at any time before starting R-REVERB1. Note that if the receiver amplifier and filter block 1425 of FIG. 14 have sufficient dynamic range, no input signal attenuation by use of attenuation divider 1455 would be necessary. If amplifier and filter block 1425 has sufficient dynamic range, then the receiver amplifier gain could simply be reduced by 10 dB so as to prevent any clipping effects. This method of reducing the transmit level within transmitter DAC 1410 has the additional benefit of reducing the power consumption in the transmitter line driver since the dynamic power required is reduced.

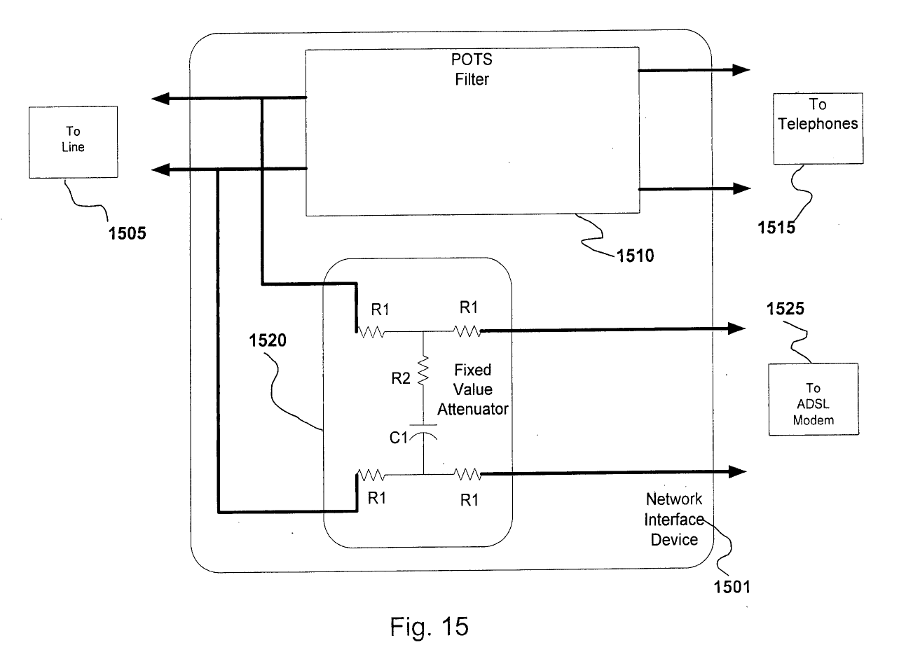

In a further embodiment of the present invention, an ADSL provider may determine manually that power cutback is being used based on the operator's outdoor cable loop plant records. As illustrated in FIG. 15, NID 1501 comprises a POTS filter 1510 and fixed attenuator 1520. A subscriber line 1505 from the outdoor cable loop plant is connected to the network side of network interface device (NID, which is the rate demarcation point for service to a subscriber) 1501. A subscriber's telephones 1515 are connected to the CP side of POTS filter 1510, and an ADSL modem 1525 is connected to the CP side of fixed attenuator 1520. In this embodiment, it is assumed that the ADSL service provider has good records characterizing the outdoor loop plant. If power cutback is being used for the loop in this example, a fixed pad would be inserted in the subscriber's NID at the time of service installation, and the connection would be restarted. The appropriate power cutback determination would be based on the cable loop plant records, or alternately from DSLAM network management platforms or from direct measurement of the characteristics of the outdoor loop plant. This embodiment requires that the pad be placed as illustrated by fixed value attenuator 1520 to ensure that the pad would not interfere with normal POTS operation.

The optimal implementation for this embodiment would be to have a single attenuation value which could cover the maximum 12 dB power cutback range. This would minimize the number of attenuator component types and installation steps the ADSL operator would be required to implement. The optimal attenuation value would be the value which reduces the power cutback from 12 dB to 0 dB. The G.992.1 standard defines the amount of power cutback to be applied to the downstream based on the information in the table below:

Parameter

| | | | | | | | |
|---|---|---|---|---|---|---|---|
| Upstream received | 3 | 4 | 5 | 6 | 7 | 8 | 9 |
| power for bins 7-18 | | | | | | | |
| [dBm]< | | | | | | | |
| Transmit loss for bins | 6 | 5 | 4 | 3 | 2 | 1 | 0 |
| 7-18 [dB] | | | | | | | |
| Maximum downstream | −40 | −42 | −44 | −46 | −48 | −50 | −52 |
| PSD to be transmitted | | | | | | | |
| based upon above bin | | | | | | | |
| 7-18 condition | | | | | | | |
| [dBm/Hz] | | | | | | | |
| Applied downstream | 0 | 2 | 4 | 6 | 8 | 10 | 12 |
| power cutback at this | | | | | | | |
| PSD[dB] | | | | | | | |

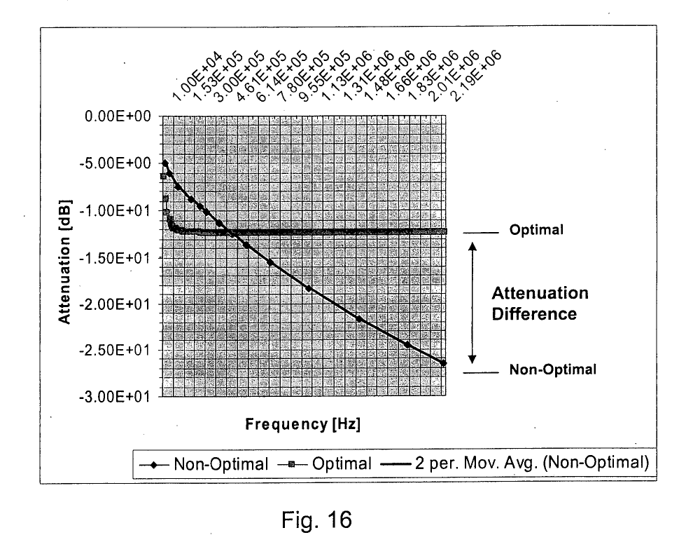

The attenuation characteristic would be so as to reduce the downstream signal by 12 dB across the entire downstream frequency range such that the CPE modem input level would not exceed the maximum input signal when power cutback was utilized (i.e. not disabled). This embodiment uses values of 33 ohms for R1, 56 ohms for R2, and 100 nF for Cl. The optimal attenuation response, as well as a non-optimal case, are illustrated in FIG. 16.

The optimal attenuation level fulfills the requirement of not increasing the dynamic range requirement of the CPE modem and provides the highest receive SNR for the ADSL system. This can be illustrated through the following example for echo cancelled G.992.1 operation. It is assumed that a power cutback condition of 0 dB exists, and the maximum transmitted power at the output of the CO modem would be (0.43152 mW per tone×249 tones (bins 7-255))=107.45 mW or +20.31 dBm. With a 12 dB power cutback applied, the maximum power received at the CPE modem input would therefore by +8.31 dB. The optimal attenuation curve has an average attenuation of 11.6 dB in the frequency range of bins 7-32 and 12.3 dB in the frequency range of bins 33-255. As such the received level at the CPE modem with the optimal attenuator installed would be 6.44 mW or +8.09 dBm. This is equivalent to an average receive bin PSD level of −52 dBm per Hz. If there was external disturbing crosstalk coupling into the CP cabling this would define the minimum obtainable SNR. For example, assume that AM radio (535-1700 kHz) signals are coupling into the premise cabling at a level of −110 dBm per Hz. With the optimal attenuation inserted the SNR would be −40 dBm per Hz −12.3 dB-(−110)=57.7 dB. As such, it is possible to maintain 14 bits per bin on the interference affected bins and no user data capacity loss results. Now assume that attenuation is inserted in the same location which mimics the attenuation of 2250 feet of 26 AWG. This is illustrated in the non-optimal attenuation versus frequency curve illustrated in FIG. 16. This value is chosen because this length of 26 AWG wire is the approximate length where power cutback would cease to be applied if the CO and CPE had this length and gauge of cable installed between them. Other cable gauges (i.e. 19, 22, 24, etc.) would have different corresponding lengths for the same operational effect. The SNR for bin 255 would be −40 dBm per Hz-18.4 dB-(−110 dBm per Hz)=51.6 dB. Since this is less than the 54 dB SNR required to load 14 bits in this bin, user data capacity would be lost. The total data capacity loss would be the summation of all bits lost across all bins. If higher frequency bins are used the impact would be even greater since the attenuation difference between the two approaches becomes even larger (as can be seen from the attenuation versus frequency graph of FIG. 16).

While the invention has been particularly shown and described with reference to an exemplary embodiment thereof, it will be understood by those skilled in the art that various changes in form and detail may be made without departing from the spirit and scope of the invention.

What is claimed is:

1. A cable assembly for minimizing crosstalk comprising:
a multi-conductor cable including a plurality of pairs of wire;
a connector having a plurality of pins disposed in a first row and a second row, said first row and said second row being parallel; and
wherein one end of each wire of said multi-conductor cable is terminated on a pin of said connector.

2. The cable assembly of claim 1 wherein each pair of wires of said multi-conductor cable are twisted along the longitudinal axis.

3. The cable assembly of claim 2 wherein each wire of each such pair of wires of said multi-conductor cable is terminated on adjacent pins in either said first row of pins or said second row of pins.

4. The cable assembly of claim 3 wherein said multi-conductor cable comprises up to twenty-five pairs of wires.

5. The cable assembly of claim 4 wherein said connector is a fifty pin shell-type connector.

6. The cable assembly of claim 5 wherein said multi-conductor cable comprises twenty-four pairs of wires;
said connector pins of said first row are numbered 1 through 25, and said connector pins of said second row are numbered 26 through 50; and
wherein pins 13 and 38 are not connected to any wire pair.

7. The cable assembly of claim 6 further comprising:
a conductive sheath covering said multi-conductor cable; and
a shell-type connector constructed of an electrically conductive material.

8. The cable assembly of claim 7 wherein said conductive sheath is mechanically and electrically connected to the conductive shell of said connector.

9. The cable assembly of claim 8 wherein said conductive sheath is connected to pins 13 and 38 of said connector.

10. The cable assembly of claim 9 wherein a first end of said multi-conductor cable is terminated by a first shell-type connector and a second end of said multi-conductor cable is terminated by a second shell-type connector.
